(19) United States
(12) Patent Application Publication
(10) Pub. No.: US 2017/0250639 A1
(43) Pub. Date: Aug. 31, 2017

(54) Pneumatic Power Generator

(71) Applicant: Stoneage, Inc., Durango, CO (US)

(72) Inventors: Easton J. LaChappelle, Durango, CO (US); Tim Schneider, Durango, CO (US)

(73) Assignee: Stoneage, Inc., Durango, CO (US)

(21) Appl. No.: 15/441,798

(22) Filed: Feb. 24, 2017

Related U.S. Application Data
(60) Provisional application No. 62/300,177, filed on Feb. 26, 2016.

(51) Int. Cl. H02P 9/04; H02K 7/18; F02C 1/02

(52) U.S. Cl. CPC H02P 9/04; F02C 1/02; H02K 7/1823

(57) ABSTRACT

A pneumatic power generator configured for generating less than about 100 W for providing on demand power to a device connected to the power generator includes a pneumatic motor coupled to an alternator with a coupling member. The pneumatic motor has an inlet port configured to receive pressurized gas to rotate an output shaft. Rotation of the output shaft is transmitted to an inlet shaft of the alternator via the coupler member. As the pressurized gas causes the pneumatic motor, the inlet shaft of the alternator rotates to produce AC power. An electronics housing is coupled to the alternator and has an electronic board and at least one power storage device. The electronic board includes a rectifier configured to convert the AC power output from the alternator into DC power for storage in a power storage device, with power being provided from the power storage device on an on-demand basis.

### CROSS-REFERENCE TO RELATED APPLICATIONS

This application claims the benefit of the filing date of U.S. Provisional Patent Application No. 62/300,177 filed Feb. 26, 2016, the disclosure of which is hereby incorporated by reference herein.

### BACKGROUND OF THE DISCLOSURE

Some mechanical devices capable of motion are controlled mostly or entirely by fluid power such as hydraulics or pneumatics. It may desirable to redesign or upgrade these types of systems to include electric power and/or electric components. It would be desirable to have a power generator to power the electronics that could easily be integrated or retrofitted into such a hydraulic or pneumatic mechanical system to power any electronics added to the system. It would further be desirable if such a power generator was capable of use in any other device requiring power, whether or not such device is a hydraulic or pneumatic type of device.

### BRIEF SUMMARY OF THE DISCLOSURE

According to a first aspect of the disclosure, a pneumatic power generator includes a pneumatic motor, a coupler member, an alternator, and an electronics housing. The pneumatic motor has an inlet port at a first end thereof configured to receive pressurized gas, and an output shaft at a second end opposite the first end, the pneumatic motor configured to convert pressurized gas into mechanical energy. The coupler member has a first bore at a first end and a second bore at a second end opposite the first end, the output shaft of the motor being positioned within the first bore and rotationally coupled to the coupler member. The alternator has an input shaft at a first end, the input shaft positioned within the second bore of the coupler member and rotationally coupled to the coupler member, the alternator configured to convert mechanical energy into AC power. The electronics housing is coupled to the alternator and has an electronic board and at least one power storage device positioned therein, the electronic board including a rectifier configured to convert AC power output from the alternator into DC power and a bidirectional DC-to-DC converter configured to store the DC power in the power storage device. The pneumatic power generator is configured for generating power less than about 100 W and at least one power storage device is configured to provide power on demand to a device connected to the power generator.

The power storage device may be a supercapacitor or a battery. A connector in the electronics housing may include a power and a ground. The power generator may include a valve system configured to regulate flow of pressurized gas into the pneumatic motor. The valve system may be mounted to the pneumatic motor. The valve system may include an inlet fitting and an outlet fitting with a valve positioned between the inlet and outlet fittings. The valve may have a closed condition in which pressurized gas is prevented from flowing from the inlet fitting to the outlet fitting, and an open condition in which pressurized gas is capable of flowing from the inlet fitting to the outlet fitting. A first tube may couple the outlet fitting of the valve system to the inlet port of the pneumatic motor. A second tube may have a first end coupled to the inlet fitting of the valve system, and a second end opposite the first end configured to be coupled to the device connected to the power generator.

According to another aspect of the disclosure, a method of providing on-demand electric power to a device with a pneumatic power generator includes directing pressurized gas from the device to an inlet port of a pneumatic motor to rotate an output shaft of the pneumatic motor. Rotation of the output shaft is transmitted to an input shaft of an alternator via a coupler member, the coupler member including a first bore coupled to the output shaft of the pneumatic motor and a second bore coupled to the input shaft of the alternator. AC power generated by the alternator is directed to an electronic board within an electronics housing coupled to the alternator and the AC power is converted into DC power via a rectifier on the electronic board. The DC power is stored in at least one power storage device in the electronics housing. The pneumatic power generator is configured for generating power less than about 100 W.

The power storage device may be a supercapacitor or a battery. The pneumatic power generator may include a valve system mounted to the power generator. The valve system may be operated to regulate flow of the pressurized gas into the inlet port of the pneumatic motor. A valve of the valve system may be closed to stop flow of the pressurized gas into the inlet port of the pneumatic motor when the power storage device reaches an upper limit power storage value. The valve of the valve system may be opened to start flow of the pressurized gas into the inlet port of the pneumatic motor when the power storage device reaches a lower limit power storage value. A first tube may couple the connected device to an inlet fitting of the valve system and a second tube may couple an outlet fitting of the valve system to the inlet port of the pneumatic motor. A valve of the valve system may have an open condition in which pressurized gas is free to flow from the connected device to the inlet port of the pneumatic motor via the valve system. The valve of the valve system may have a closed condition which restricts pressurized gas from flowing from the connected device to the inlet port of the pneumatic motor.

According to yet another aspect of the disclosure, a pneumatic power generator includes a pneumatic motor having an inlet port at a first end thereof configured to receive pressurized gas, and an output shaft at a second end opposite the first end, the pneumatic motor configured to convert pressurized gas into mechanical energy. A coupler member has a first portion and a second portion, the output shaft of the motor being rotationally coupled to the first portion of the coupler member. An alternator has an input shaft at a first end, the input shaft rotationally coupled to the second portion of the coupler member, the alternator configured to convert mechanical energy into AC power when torque of the output shaft of the motor is transmitted to the input shaft of the alternator via the coupler member. Electronic components are coupled to the alternator and include an electronic board and at least one power storage device, the electronic board including a rectifier configured to convert AC power output from the alternator into DC power and a bidirectional DC-to-DC converter configured to store the DC power in the power storage device. The pneumatic power generator is configured for generating power less than about 100 W and the at least one power storage device is configured to provide power on demand to a device connected to the power generator.

The power storage device may be a supercapacitor or a battery. The electronic components may include a connector including a power and a ground. A valve system may be configured to regulate flow of pressurized gas into the pneumatic motor. The valve system may be mounted to a housing the pneumatic motor. The valve system may include an inlet fitting and an outlet fitting with a valve positioned between the inlet and outlet fittings. The valve may have a closed condition in which pressurized gas is prevented from flowing from the inlet fitting to the outlet fitting, and an open condition in which pressurized gas is capable of flowing from the inlet fitting to the outlet fitting. A first tube may couple the outlet fitting of the valve system to the inlet port of the pneumatic motor. A second tube may have a first end coupled to the inlet fitting of the valve system and a second end opposite the first end configured to be coupled to the device connected to the power generator. At least some of the electronic components may be in contact with the pneumatic motor. The first portion of the coupler member may a first gear and the second portion of the coupler member may be a second gear. The first gear and the second gear may have a 1:1 gear ratio.

According to still another aspect of the disclosure, a method of providing on-demand electric power to a device with a pneumatic power generator includes directing pressurized gas from the device to an inlet port of a pneumatic motor to rotate an output shaft of the pneumatic motor. Rotation of the output shaft may be transmitted to an input shaft of an alternator via a coupler member, the coupler member including a first portion coupled to the output shaft of the pneumatic motor and a second portion coupled to the input shaft of the alternator. AC power generated by the alternator may be directed to an electronic board operatively coupled to the alternator and the AC power may be converted into DC power via a rectifier on the electronic board. The DC power may be stored in at least one power storage device. The pneumatic power generator may be configured for generating power less than about 100 W.

The power storage device may be a supercapacitor or a battery. The pneumatic power generator may include a valve system mounted to the power generator. The method may also include operating the valve system to regulate flow of the pressurized gas into the inlet port of the pneumatic motor. The method may further include closing a valve of the valve system to stop flow of the pressurized gas into the inlet port of the pneumatic motor when the power storage device reaches an upper limit power storage value. The method may still further include opening a valve of the valve system to start flow of the pressurized gas into the inlet port of the pneumatic motor when the power storage device reaches a lower limit power storage value. A first tube may couple the connected device to an inlet fitting of the valve system and a second tube may couple an outlet fitting of the valve system to the inlet port of the pneumatic motor. A valve of the valve system may have an open condition in which pressurized gas is free to flow from the connected device to the inlet port of the pneumatic motor via the valve system. The valve of the valve system may have a closed condition which restricts pressurized gas from flowing from the connected device to the inlet port of the pneumatic motor.

### BRIEF DESCRIPTION OF THE DRAWINGS

FIG. 1A is a perspective view of a pneumatic power generator according to one aspect of the disclosure.

FIG. 1B is a side view of the pneumatic power generator of FIG. 1A.

FIG. 2A is a cross section of certain components of the pneumatic power generator of FIGS. 1A-B.

FIG. 2B is a perspective view certain components of the pneumatic power generator of FIGS. 1A-B.

FIG. 3A is a perspective view of a pneumatic motor of the pneumatic power generator of FIGS. 1A-B.

FIG. 3B is a perspective view of the pneumatic motor of FIG. 3A coupled to a coupling member.

FIG. 4A is an enlarged perspective view of the coupling member of FIG. 3B, with FIGS. 4B and 4C providing perspective views of components of the coupling member of FIG. 3B.

FIGS. 5A-B are isolated perspective views of an alternator of the pneumatic power generator of FIGS. 1A-B.

FIG. 6 is an isolated perspective view of an electronics housing of the pneumatic power generator of FIGS. 1A-B.

FIGS. 7A-C are various views of the pneumatic power generator of FIGS. 1A-B illustrating a valve system of the power generator.

FIGS. 8A-D are various views of a pneumatic power generator according to another aspect of the disclosure.

### DETAILED DESCRIPTION

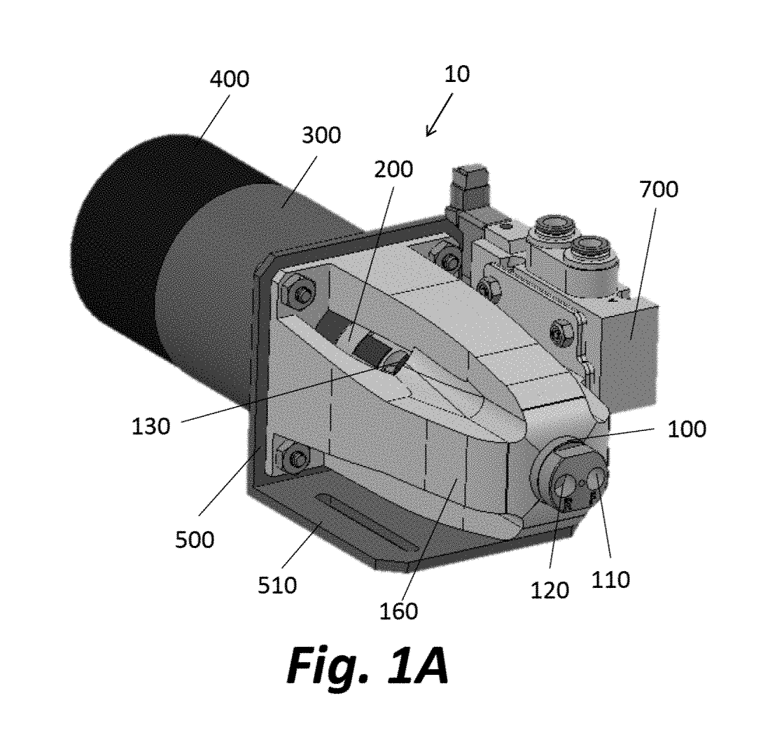

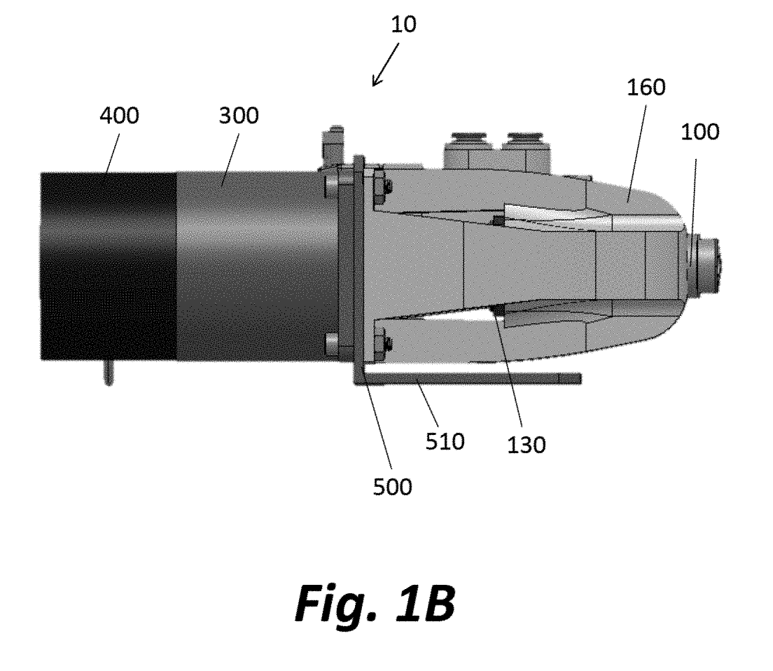

FIGS. 1A-B show a pneumatic power generator 10 according to one aspect of the disclosure. Generally, power generator 10 may generally include a pneumatic motor 100, a coupling member 200, an electric alternator 300, an electronics housing 400, and a valve system 700. The pneumatic power generator 10 is particularly adapted for generating low power, for example in the range of under 100 Watts, from compressed gasses to provide on demand power and to store usable power within a self-contained system.

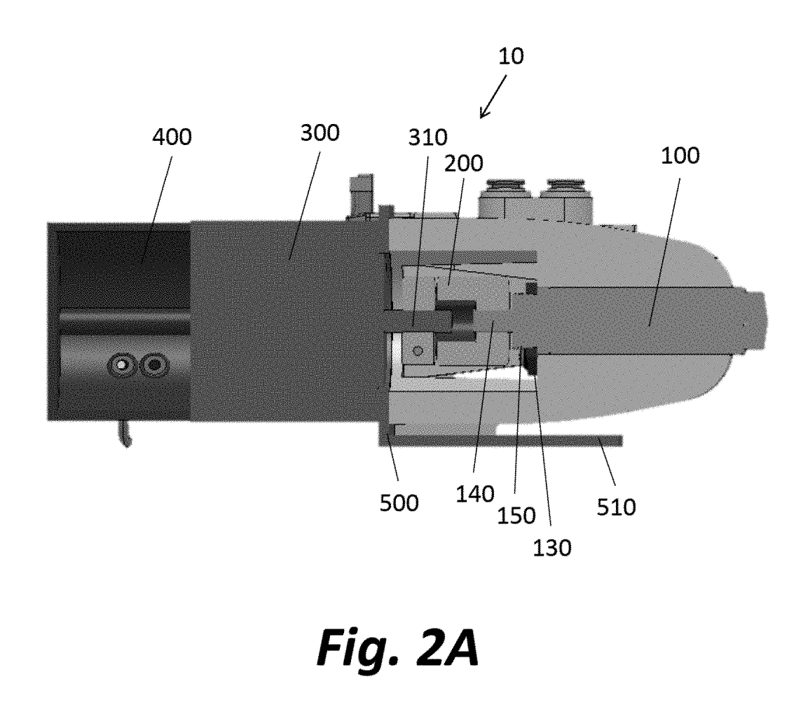

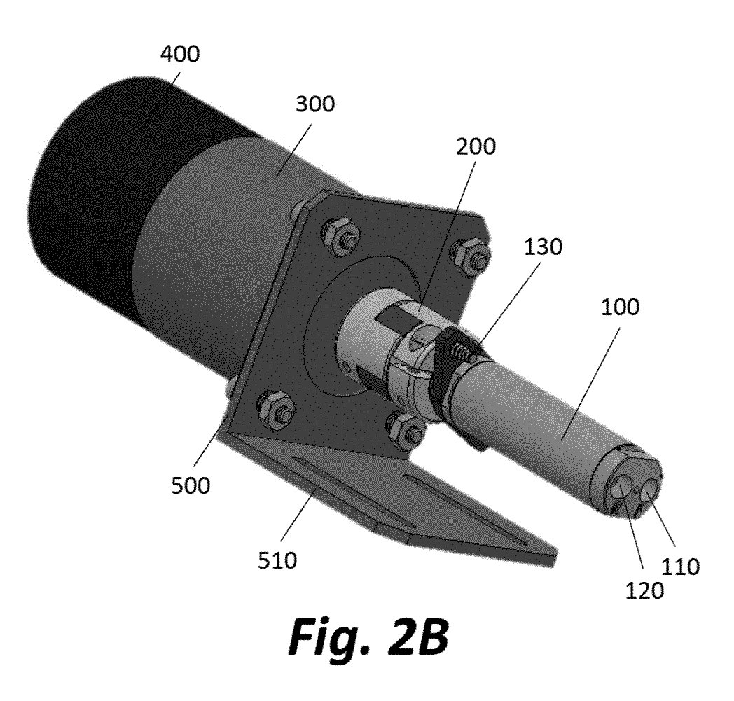

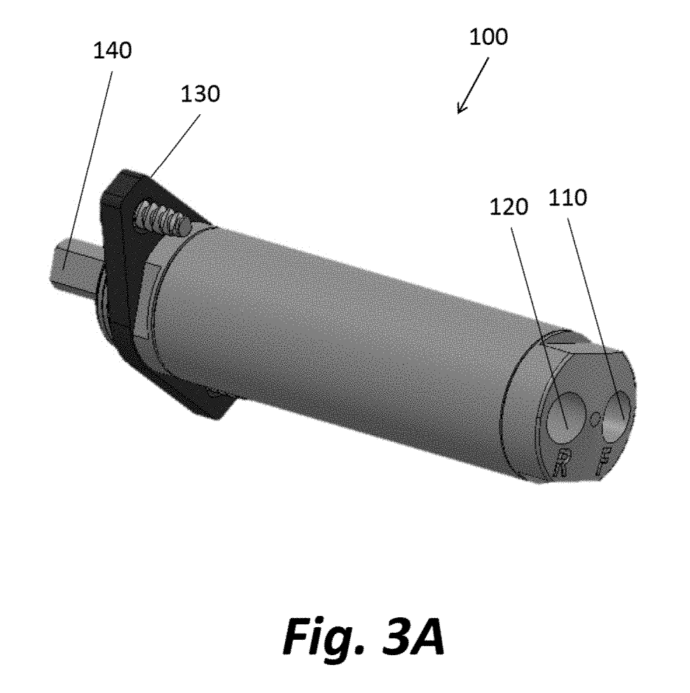

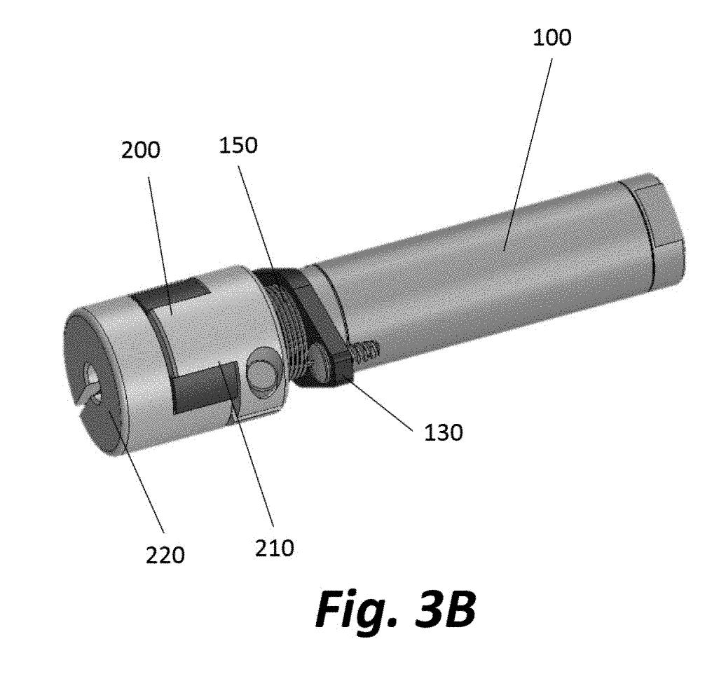

The pneumatic motor 100 is best illustrated in FIGS. 2A-3B. In one example, the pneumatic motor 100 is a Micro Motors MMR-0700 air motor offered by Pro-Dex, Inc. of Irvine, Calif., although other types of pneumatic motors may be suitable for use in pneumatic power generator 10. However, it should be understood that the power generator 10 is not limited to use with this particular motor, and other pneumatic motors may be suitable for use. Pneumatic motor 100 may include a first port 110 and a second port 120, both positioned on a first end of the motor 100. The first port 110 may be an inlet port which may be coupled to a source of compressed gas, for example via an adapter. As compressed gas passes through the first port 110, the motor 100 causes a motor shaft 140 to rotate in a first direction. The second port 120 may be used as an exhaust port which may be throttled, for example using a flow control device, to control the speed of the pneumatic motor 100. The pneumatic motor 100 may take the form of a vane motor, but other types of motors including air turbine and piston motors may be suitable for use in pneumatic power generator 10. The flow and pressure of the gas entering the motor 100 determines the rotational torque and speed of the motor 100. The gasses that may be input into pneumatic motor 100 may include oxygen, nitrogen, and/or helium, although other types of gases may be suitable.

Pneumatic motor 100 may also have a flange member 130 and a threaded shaft 150. The flange member 130 may include internal threading to thread to the threaded shaft 150 of the motor 100. Flange 130 includes one or more apertures that align with one or more apertures in motor mount 160 so that a screw or other fastener may securely fix flange 130 to motor mount 160, preventing rotational movement between the housing of motor 100 and motor mount 160. It should be understood that other types of structures may be suitable to couple the pneumatic motor 100 to the motor mount 160.

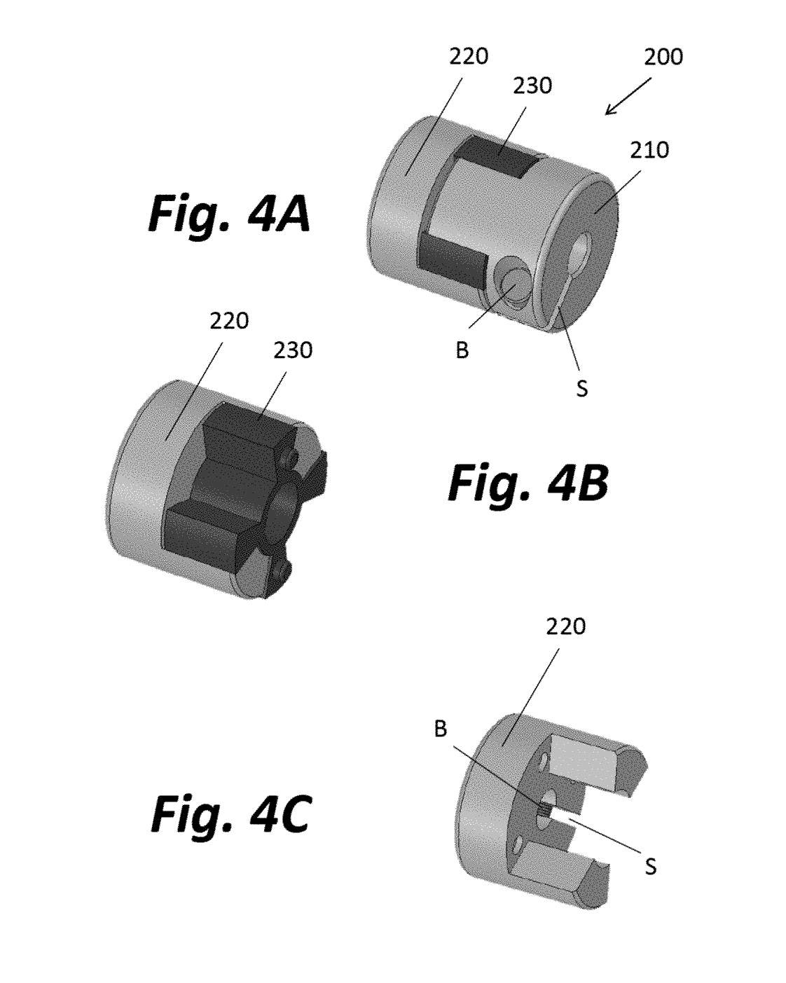

The output shaft 140 of the motor 100 is coupled to the alternator 300 via a coupling member 200. Output shaft 140 may include at least one flat surface or other geometry to permit torque to be transmitted from the output shaft 140 to coupling member 200. An adapter or other member may be positioned over output shaft 140 to provide a desired geometric coupling between the output shaft 140 and coupling member 200. Otherwise, coupling member 200 may be compressed tightly over output shaft 140 to permit torque to be transmitted to allow for any desired geometry between coupling member 200 and output shaft 140. Coupling member 200 is illustrated best in FIGS. 4A-C. Coupling member 200 includes a first member 210 having a first bore on a first end of the coupling member 200 and a second member 220 having a second bore on a second end of the coupling member 200. The first member 210 may include a slot S that accepts a screw or a bolt B, wherein tightening the bolt B closes the slot S to compress the bore in the first member 210 tightly over the output shaft 140 of the pneumatic motor 100, so that rotation of output shaft 140 causes rotation of the first member 210. The second member 220 may have a similar construction so that tightening of a bolt B closes a slot S of the second member 220 to cause the bore in the second member 220 to tightly compress over an input shaft 310 of alternator 300, so that rotation of the second member 220 causes rotation of the input shaft 310. An intermediate member 230 may be positioned between first member 210 and second member 220 so that rotation of the first member 210 is transmitted to the second member 220, effectively coupling rotation of the output shaft 140 of the motor 100 to the input shaft 310 of the alternator 300. The illustrated coupling member 200 may be an elastomer coupler or a spider coupler which helps the system operate even if there is a misalignment between the output shaft 140 and the input shaft 310, although other types of couplers may be suitable. For example, the rotational torque and speed from the motor 100 may be coupled to the alternator 300 using a series of gears or other power transfer mechanisms.

A mounting bracket 500 may optionally be provided with pneumatic power generator 10 to provide additional stability in connecting the power generator 10 to a device into which it is integrated. Mounting bracket 500 may include a plurality of apertures that align with corresponding apertures in motor mount 160 and alternator 300 so that the three components may be securely fixed to each other with fasteners or the like. As illustrated, mounting bracket 500 includes an additional flange 510 that may be used to securely fix mounting bracket 500 to the connected device. In the particular example illustrated, flange 510 of mounting bracket 500 includes two elongated slots to allow for mounting of mounting bracket 500 to the connected device at any position along the elongated slots using fasteners or the like. It should be understood that other configurations, such as apertures, may be used alternatively to the elongated slots in flange 510.

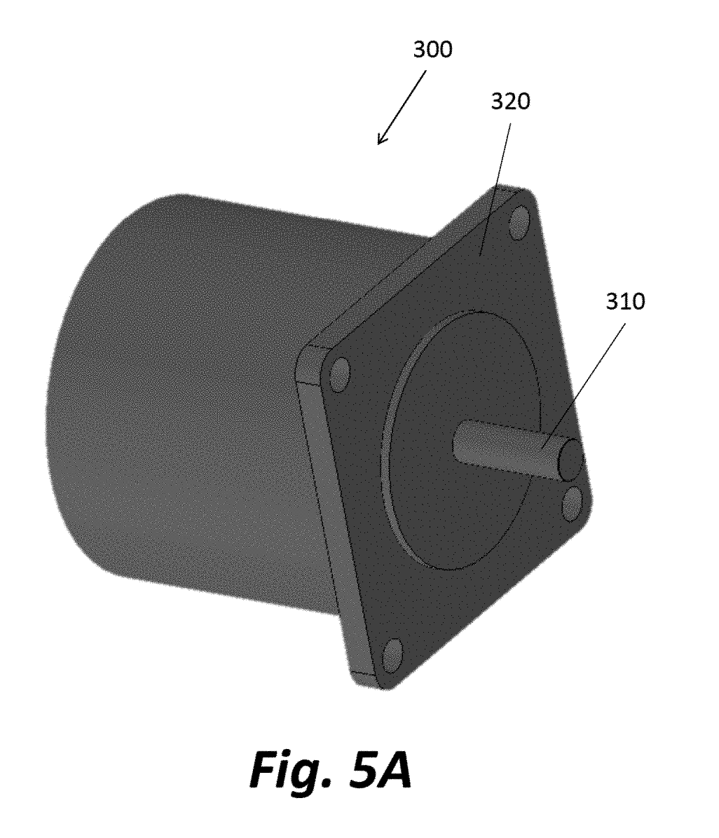

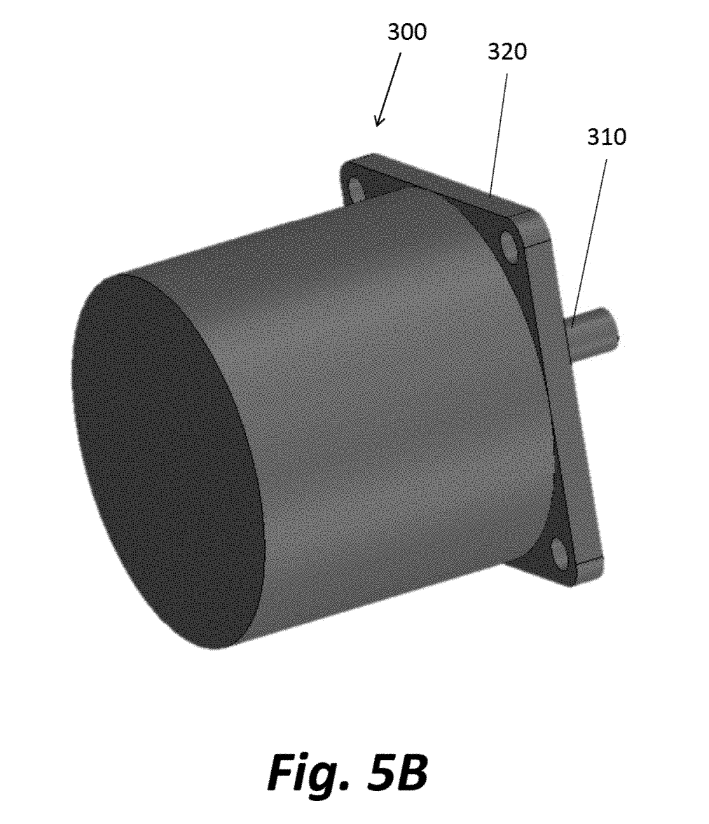

Alternator 300 is illustrated isolated from the other components of the pneumatic power generator 10 in FIGS. 5A-B. Alternator 300 may include a mounting flange 320 with apertures to facilitate secure coupling of the alternator 300 to the mounting bracket 500 and motor mount 160 as described above. As compressed gas enters motor 100 and causes output shaft 140 to rotate, and thus coupling member 200 and input shaft 310 to rotate, the rotational torque is turned into AC power. In the illustrated example, alternator 300 takes the form of a brushless permanent magnet three-phase AC motor, although other types of alternators may be suitable for use in pneumatic power generator 10. The output of alternator 300 is directly proportionate to the number of rotations of the input shaft 310.

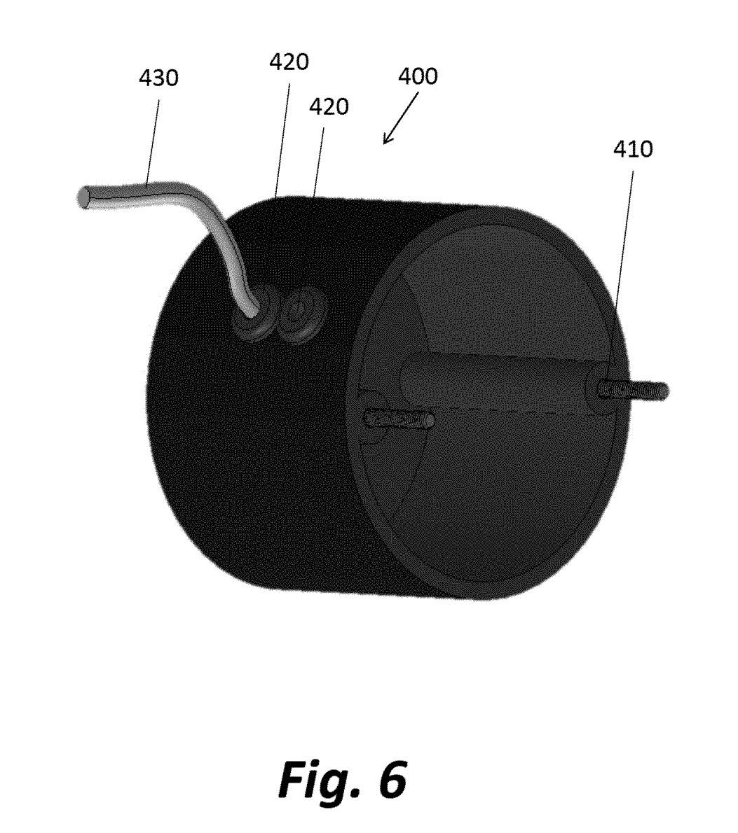

The electronics housing 400 is illustrated in FIG. 6 isolated from the rest of the components of pneumatic power generator 10. The electronic housing may generally be hollow inside and be configured to couple to alternator 300 via one or more apertures 410 or the like. Generally, electronics housing 400 houses an electronic board and one or more super capacitors. The electronic board may include a rectifier to convert the raw AC output of the alternator 300 into raw DC power. The raw DC power may then be routed into a bidirectional DC-to-DC converter which is where the energy is stored in the super capacitors and regulated, for example, for a 12-volt output. A two-pin connector may also be positioned within electronics housing 400, for example on an end or a side of the housing 400. In one example, the two-pin connector may include a power and a ground. The power and ground is the regulated output from the bidirectional DC-to-DC converter and may have a maximum output of 60 volts, 2.5 amps, and a peak output of about 5 to about 50 watts depending on the model.

As should be understood from the above, the AC power generated by alternator 300 is rectified and stored in energy storage devices, which may provide the stored energy to electronics in the device on a demand basis. The power generated by pneumatic power generator 10 is preferably low power, on the order of less than about 100 Watts, the generated energy being stored in storage devices that may include, for example, batteries and capacitors in electronics housing 400. When the storage devices have charged to a high threshold capacity, the pneumatic motor 100 may be shut down by operation of valve system 700, described in greater detail below. As electronic components of the device incorporating pneumatic power generator 10 draw power on an on-demand basis from the storage devices, the charge stored in the storage devices will reduce until a low threshold is reached. In one example, power may be provided via wires 430 extending from inside electronics housing 400 through grommets 420 (or other suitable sealing components) the wires 430 including a two-pin in line connector to interface with the device demanding the power. Once enough power is drawn so that the storage devices reach the low threshold is reached, the valve system 700 may be further operated so that pneumatic motor 100 can continue operating to charge the storage devices again until they reach the high threshold capacity again.

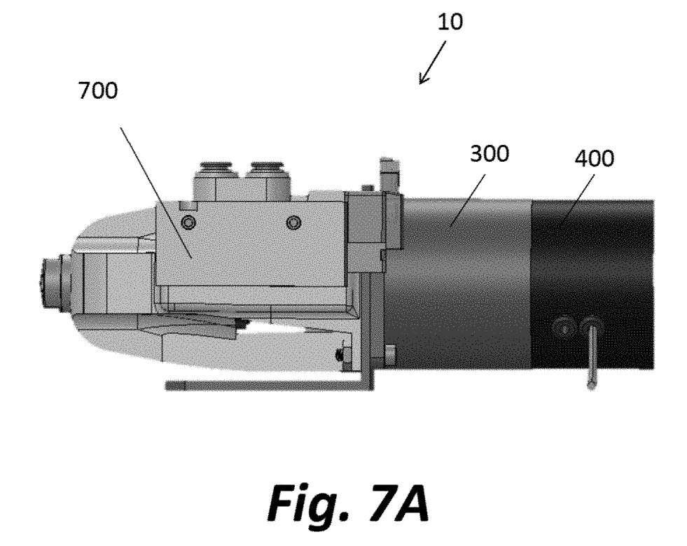

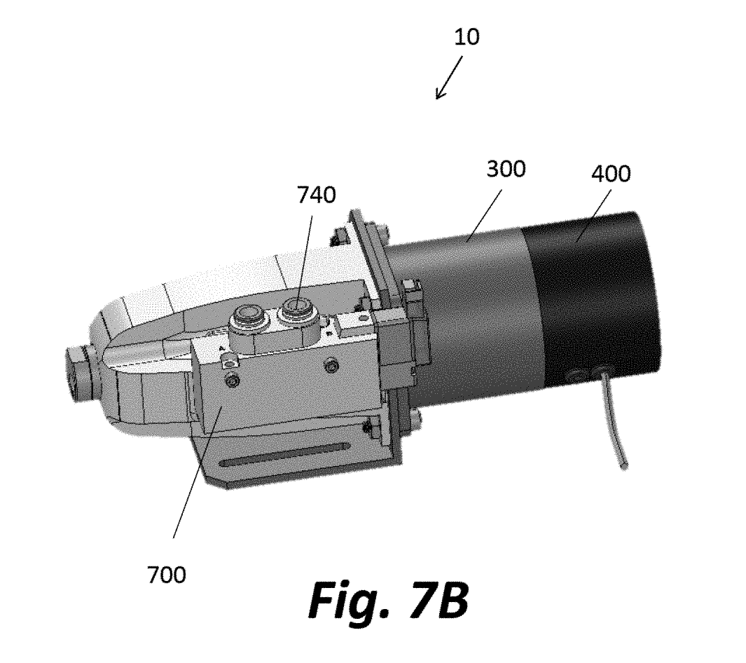

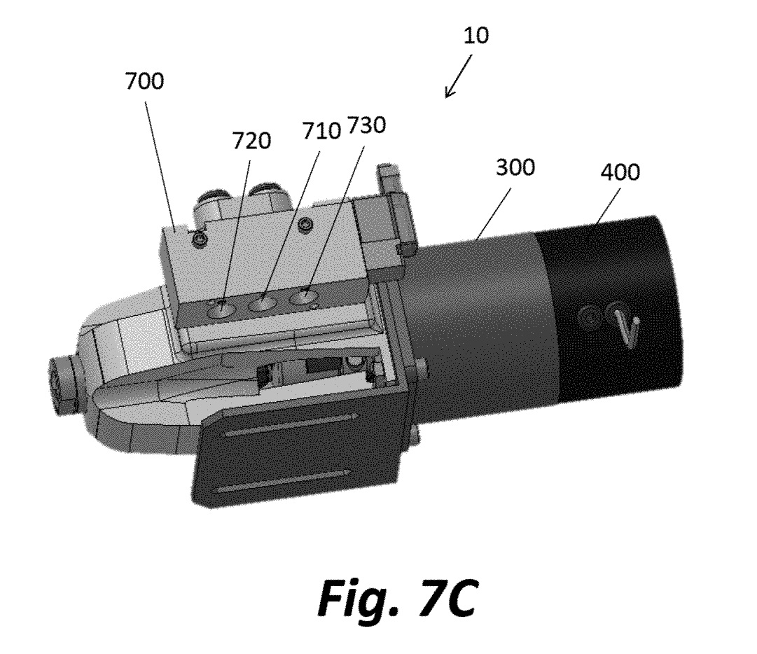

Valve system 700 is best illustrated in FIGS. 7A-C. Valve system 700 may include an enclosure mounted to motor mount 160, for example by fasteners. Valve system 700 may include a two-pin connector that connects to electronics housing 700 (connection not illustrated). As noted above, valve system 700 may be operated to allow compressed gas to flow into pneumatic motor 100 when the power storage devices are at (or below) a low power threshold and in need of charging, or otherwise operated to stop compressed gas from flowing into pneumatic motor 100 when the power storage devices have reached a high power threshold and are no longer in need of charging. For example, a main air source may be routed from the connected device to a fitting 710 on an underside of valve system 700 via a tube or other suitable line, as best seen in FIG. 7C (tube omitted from drawing for clarity). Additional fittings 720, 730 may be provided to provide for connection to external sources, although in the illustrated embodiment such fittings 720, 730 may be omitted or plugged (or otherwise sealed). Another fitting 740 may be provided on the top of valve system 700, with another tube or suitable line connecting fitting 740 to the inlet 110 of the pneumatic motor 100, as best seen in FIG. 7B (tube omitted from drawing for clarity). With this configuration, compressed gas initially moves from the connected device to the valve system 700 via the tube coupling the connected device to fitting 710. Preferably, the valve within valve system 700 is initially in an open state, so that the compressed gas may freely exit fitting 740 and travel to inlet 110 via a tube connecting fitting 740 and inlet 110. The compressed gas ultimately generates electricity that is stored as described above, until the storage devices are charged to the high threshold. At this point, the electronics within electronics housing 400 may send a signal to the valve system 700, for example via a wire (similar to wire 430) extending from the electronics housing 400 to the valve system 700 through grommet 420 (wire not illustrated in FIGS. 7A-C) to instruct the valve within valve system 700 to close. In the closed state, compressed air entering valve system 700 via fitting 710 is prevented from exiting valve system 700 via fitting 740, so that no compressed gas enters pneumatic motor 100. The connected device continues to drain power from the storage devices in electronics housing 400 until the charge in the storage devices falls to a low threshold. Upon falling to this low threshold, the electronics within electronics housing 400 send another signal to valve system 700 to open the valve, so that the compressed gas may continue to flow to recharge the storage devices in electronics housing 400.

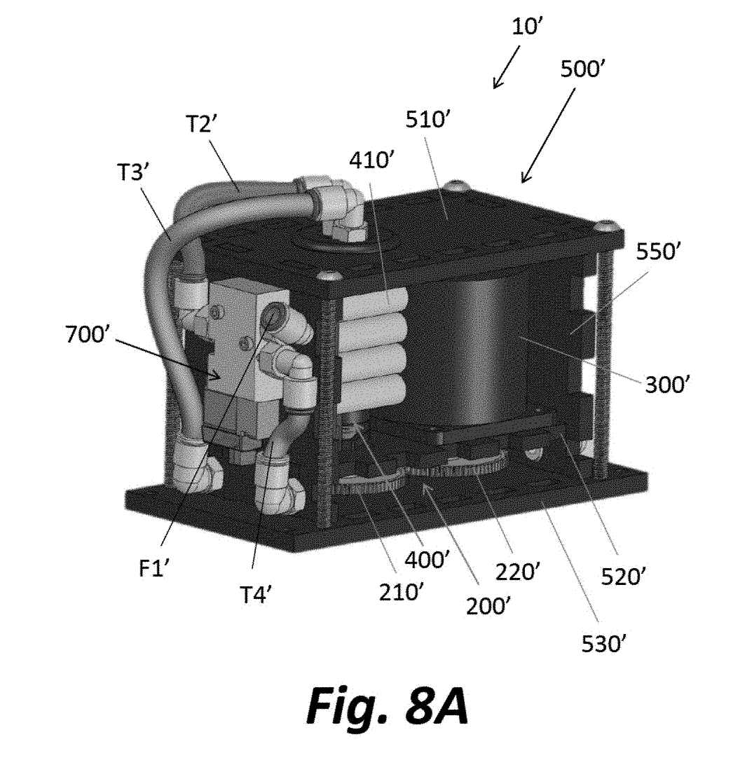

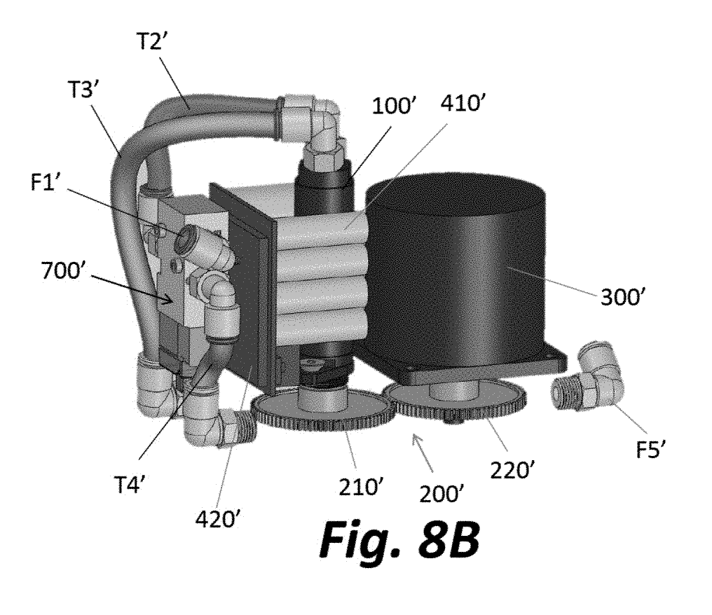

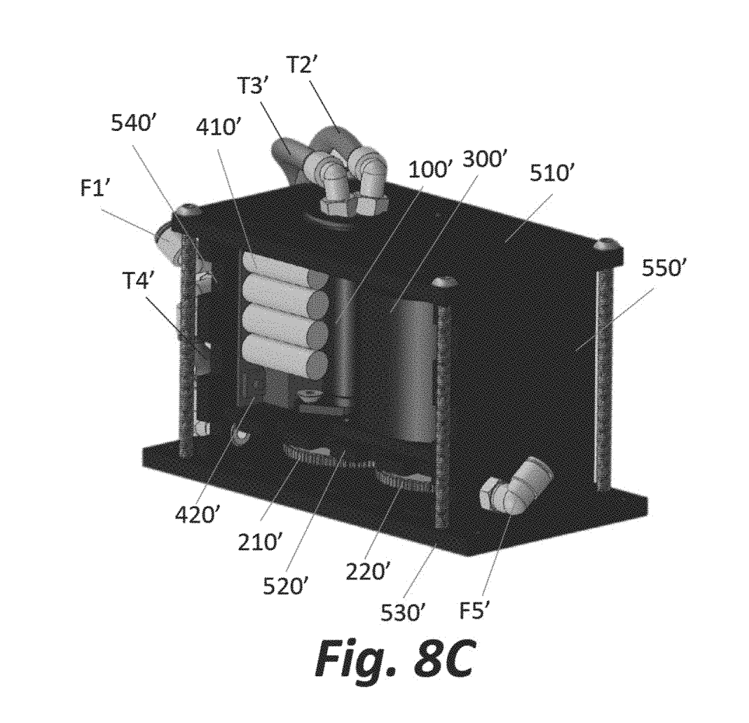

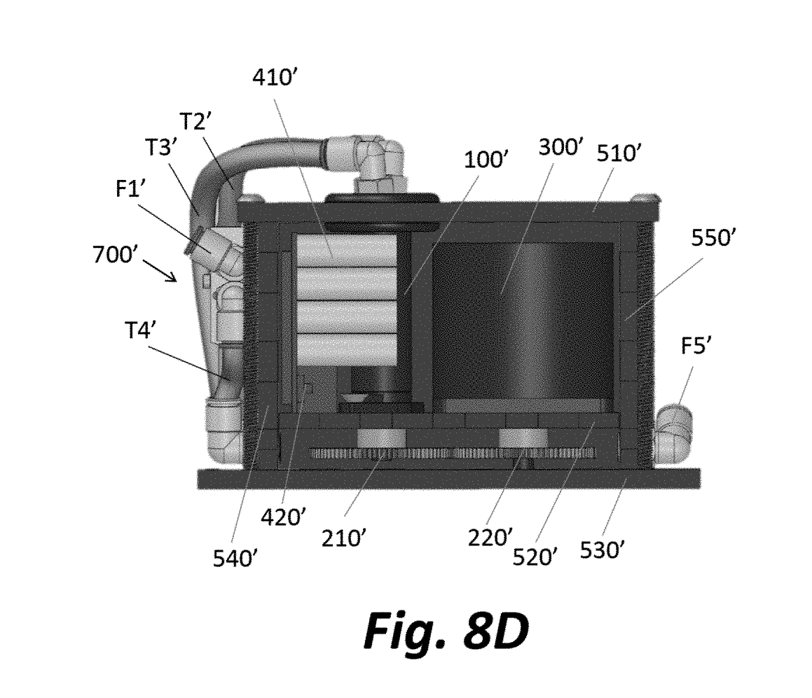

FIGS. 8A-D illustrate an alternate embodiment of power generator 10′ which includes many features that are similar or identical to power generator 10, although certain components are arranged differently. For example, power generator 10′ includes a pneumatic motor 100′ (best illustrated in FIG. 8B), a coupling member 200′, an electric alternator 300′, electronic components 400′, housing 500′, and a valve system 700′. Similar to power generator 10, power generator 10′ may be particularly adapted for generating low power, for example in the range of under 100 Watts, from compressed gasses to provide on demand power and to store usable power within a self-contained system.

FIG. 8B illustrates power generator 10′ with housing 500′ omitted to better illustrate the other components of the power generator. Pneumatic motor 100′ may be similar or identical to pneumatic motor 100. A first or top end of pneumatic motor 100′ may include an inlet port adapted for coupling to a tube T2′. Tube T2′ may also be coupled to valve system 700′, wherein compressed gas flows from valve system 700′, through tube T2′ and into the inlet of pneumatic motor 100′. The first or top end of pneumatic motor 100′ may also include an exhaust port adapted to couple to another tube T3′. The exhaust port may be throttled, for example using a flow control device, to control the speed of pneumatic motor 100′. The first end of pneumatic motor 100′ may be coupled to a top face 510′ of housing 500′, with tubes T2′ and T3′ coupled to the pneumatic motor through the top face of the housing.

A second or bottom end of pneumatic motor 100′ may include a flange member similar to flange member 300 that may be coupled to an interior support 520′ of housing 500′, for example via screws, bolts, or other fasteners. A motor shaft may extend from the second or bottom end of pneumatic motor 100′ and into a first gear 210′ of coupling member 200′. First gear 210′ may be a spur gear positioned between interior support 520′ and bottom face 530′ of housing 500′. Coupling member 200′ may include a second gear 220′, which may also be a spur gear, adjacent to and engaged with first gear 210′. In the illustrated embodiment, gears 210′ and 220′ have a one-to-one gear ratio, but it should be understood that other gear ratios may be used if desired. Second gear 220′ may be coupled to an input shaft of alternator 300′. Alternator 300′ may be similar or identical to alternator 300. With the configuration described above, activation of pneumatic motor 100′ for example by compressed gas, results in the rotation of the input shaft of alternator 300′ via interaction with the coupling members 200′. It should be noted that one difference between power generator 10 and power generator 10′ is that, in power generator 10, the pneumatic motor 100 is axially aligned with the alternator 300, which is made possible by coupling member 200, whereas in power generator 10′, the pneumatic motor 100′ and alternator 300′ are positioned side-by-side, which is made possible in the illustrated embodiment by coupling member 200′.

Valve system 700′ may be identical or similar to valve system 700. Valve system 700′ may include a fitting F1′ adapted to couple to a tube (not illustrated), which may in turn be connected to a connected device which provides for a main air source to the valve system 700′. Valve system 700′ may function identically or similarly to valve system 700, allowing compressed gas to flow through the tube connected to fitting F1′ into valve system 700′ and then through tube T2′ to pneumatic motor 100′ when the charge storage devices are at a low threshold. Similar to generator 10, generator 10′ charges the storage devices through compressed air flowing to pneumatic motor 100′ and in turn rotating the input shaft of alternator 300′, with charge flowing from the alternator to the storage devices. Once the storage devices reach a high threshold, valve system 700′ may prevent compressed air flowing into the valve system from the tube connected to fitting F1′ from passing to tube T2′, so that the pneumatic motor 100′ does not operate when charging the storage devices is unnecessary. Exhaust from the valve system 700′ may pass through tube T4′. Both exhaust tubes T3′ and T4′ may be connected to side wall 540′ so that the exhaust passes into the space in which coupling member 200′ is positioned. The exhaust may serve to lubricate the gears 210′ and 220′ of coupling member 200. Remaining exhaust may exit the housing 500′ from a tube (not shown) coupled to fitting F5′.

Electronic components 400′ are best illustrated in FIG. 8B. Electronic components 400′ may include, but are not limited to, one or more storage devices 410′ and an electronics board 420′. The storage devices 410′ may be super capacitors, or any other suitable storage devices. The electronics board 420′ may be fixed to a side face 540′ of housing 500′. In the illustrated embodiment, valve system 700′ is coupled to the side face 540′ on the opposite side of electronics board 420′. Electronics board 420′ may be similar or identical to the electronics board described in connection with generator 10. For example, electronics board 420′ may include a rectifier to convert the raw AC output of the alternator 300′ into raw DC power. The raw DC power may then be regulated and stored in the storage devices 410′. Electronics board 420′ may be coupled to valve system 700′ and/or alternator 300′ via one or more connections (not shown) to facilitate storing the energy from the alternator and to facilitate operating the valve system. In the illustrated embodiment, electronics board 420′ and/or storage devices 410′ may be in direct contact with, or in close proximity with, pneumatic motor 100′. When valve system 700′ is in the open position to allow compressed gas to flow to pneumatic motor 100′, the compressed gas, which is typically at a low temperature, may help cool the electronic components.

Housing 500′ may include, in addition to top face 510′, interior support 520′, bottom face 530′, and side face 540′, at least one additional side face 550′. Interior support 520′ may be positioned between top face 510′ and bottom face 530′, with the interior support being supported by connections to side faces 540′, 550′. The top face 510′ may be coupled to bottom face 530′ via the at least two sides faces 540′, 550′, and a plurality of bolts or other fasteners. Although only two side faces 540′ and 550′ are shown, it should be understood that two additional side faces (not shown) may be included to fully encapsulate the pneumatic motor 100′, the coupling member 200′, the alternator 300′, and the electronic components 400′. The positioning of the various components of generator 10′, which may be made possible at least in part by the coupling member 200′ and the housing 500′, may provide certain benefits over generator 10. For example, as noted above, positioning of the electronic components 400′ next to the pneumatic motor 100′ may provide a cooling function for the electronic components. Still further, the partial or complete enclosure of the pneumatic motor 100′, coupling member 200′, alternator 300′, and electronic components 400′ may provide for a small and convenient form factor, easy manufacturing, and a safety function by enclosing components that, in certain situations, could be dangerous if they were exposed. However, in most other aspects, operation of power generator 10′ is identical to the operation of power generator 10 described above.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A pneumatic power generator, comprising:
a pneumatic motor having an inlet port at a first end thereof configured to receive pressurized gas, and an output shaft at a second end opposite the first end, the pneumatic motor configured to convert pressurized gas into mechanical energy;
a coupler member having a first portion and a second portion, the output shaft of the motor being rotationally coupled to the first portion of the coupler member;
an alternator having an input shaft at a first end, the input shaft rotationally coupled to the second portion of the coupler member, the alternator configured to convert mechanical energy into AC power when torque of the output shaft of the motor is transmitted to the input shaft of the alternator via the coupler member; and
electronic components coupled to the alternator and including an electronic board and at least one power storage device, the electronic board including a rectifier configured to convert AC power output from the alternator into DC power and a bidirectional DC-to-DC converter configured to store the DC power in the power storage device,
wherein the pneumatic power generator is configured for generating power less than about 100 W and the at least one power storage device is configured to provide power on demand to a device connected to the power generator.

2. The power generator of claim 1, wherein the power storage device is a supercapacitor.

3. The power generator of claim 1, wherein the power storage device is a battery.

4. The power generator of claim 1, wherein the electronic components include a connector including a power and a ground.

5. The power generator of claim 1, further comprising a valve system configured to regulate flow of pressurized gas into the pneumatic motor.

6. The power generator of claim 5, wherein the valve system is mounted to a housing of the pneumatic motor.

7. The power generator of claim 5, wherein the valve system includes an inlet fitting and an outlet fitting with a valve positioned between the inlet and outlet fittings.

8. The power generator of claim 7, wherein the valve has a closed condition in which pressurized gas is prevented from flowing from the inlet fitting to the outlet fitting, and an open condition in which pressurized gas is capable of flowing from the inlet fitting to the outlet fitting.

9. The power generator of claim 8, further comprising a first tube coupling the outlet fitting of the valve system to the inlet port of the pneumatic motor.

10. The power generator of claim 9, further comprising a second tube having a first end coupled to the inlet fitting of the valve system, and a second end opposite the first end configured to be coupled to the device connected to the power generator.

11. The power generator of claim 1, wherein at least some of the electronic components are in contact with the pneumatic motor.

12. The power generator of claim 1, wherein the first portion of the coupler member is a first gear and the second portion of the coupler member is a second gear.

13. The power generator of claim 12, wherein the first gear and the second gear have a 1:1 gear ratio.

14. A method of providing on-demand electric power to a device with a pneumatic power generator comprising:
directing pressurized gas from the device to an inlet port of a pneumatic motor to rotate an output shaft of the pneumatic motor;
transmitting rotation of the output shaft to an input shaft of an alternator via a coupler member, the coupler member including a first portion coupled to the output shaft of the pneumatic motor and a second portion coupled to the input shaft of the alternator;
directing AC power generated by the alternator to an electronic board operatively coupled to the alternator and converting the AC power into DC power via a rectifier on the electronic board; and
storing the DC power in at least one power storage device,
wherein the pneumatic power generator is configured for generating power less than about 100 W.

15. The method of claim 14, wherein the pneumatic power generator includes a valve system mounted to the power generator, and the method includes operating the valve system to regulate a flow of the pressurized gas into the inlet port of the pneumatic motor.

16. The method of claim 15, further comprising closing a valve of the valve system to stop flow of the pressurized gas into the inlet port of the pneumatic motor when the power storage device reaches an upper limit power storage value.

17. The method of claim 15, further comprising opening a valve of the valve system to start flow of the pressurized gas into the inlet port of the pneumatic motor when the power storage device reaches a lower limit power storage value.

18. The method of claim 15, wherein a first tube couples the connected device to an inlet fitting of the valve system and a second tube couples an outlet fitting of the valve system to the inlet port of the pneumatic motor.

19. The method of claim 18, wherein a valve of the valve system has an open condition in which pressurized gas is free to flow from the connected device to the inlet port of the pneumatic motor via the valve system.

20. The method of claim 19, wherein the valve of the valve system has a closed condition which restricts pressurized gas from flowing from the connected device to the inlet port of the pneumatic motor.
